(19) United States
(12) Patent Application Publication
(10) Pub. No.: US 2007/0230930 A1
(43) Pub. Date: Oct. 4, 2007

(54) METHODS AND SYSTEMS FOR AUTOMATIC IMAGE ACQUISITION

(75) Inventor: Chia Tse Chang, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/670,390

(22) Filed: Feb. 1, 2007

(30) Foreign Application Priority Data
Feb. 3, 2006 (TW) TW95103768

(51) Int. Cl. G03B 17/00

(52) U.S. Cl. 396/49

(57) ABSTRACT

The present invention relates to digital imaging apparatuses, and method and system for automatic image acquisition. The method of present invention comprises acquiring a first image and a second image. The method further comprises acquiring a first sub-image from the first image and acquiring a second sub-image from the second image. It is determined whether the difference between the first sub-image and the second sub-image satisfies a predetermined condition, and, if so, a third image is acquired via an image processor and the third image is stored in a storage device.

### BACKGROUND

The present invention relates to digital imaging apparatuses, and more particularly, to methods and systems for automatic image acquisition.

Digital imaging apparatuses such as digital cameras, digital video recorders and others, are typically equipped with self-timers for automatically acquiring images after a predetermined time period such as three, five seconds or similar has elapsed. Subjects, however, may move after the predetermined time period, resulting in blurred images.

### SUMMARY

The present invention relates to digital imaging apparatuses, and method and system for automatic image acquisition. The method of present invention comprises acquiring a first image and a second image. The method further comprises acquiring a first sub-image from the first image and acquiring a second sub-image from the second image. It is determined whether the difference between the first sub-image and the second sub-image satisfies a predetermined condition, and, if so, a third image is acquired via the image processor and the third image is stored in the storage device.

An embodiment of a method for automatic image acquisition may further comprise the following steps. RGB data of the first image is converted into grayscale, halftone or luminance data thereof, and RGB data of the second image is converted into grayscale, halftone or luminance data thereof before acquiring the first and second sub-images.

An embodiment of a method for automatic image acquisition may further comprise the following steps before acquiring the first and second images. A fourth image is acquired. A fifth image is acquired. Analysis areas substantially with the same image formation are determined from the fourth and the fifth image respectively. Pixel data between analysis areas of the fourth image and the fifth image may be substantially the same. The first sub-image may be acquired from the analysis area of the first image, and the second sub-image may be acquired from the analysis area of the second image. An embodiment of a step for acquiring the fifth image may further comprise acquiring a first configuration setting by adjusting the digital imaging apparatus with the maximum diaphragm, and acquiring the fifth image through the image processor by controlling the digital imaging apparatus according to the first configuration setting. An embodiment of a step for acquiring the fourth image may further comprise determining a second configuration setting corresponding to a first diaphragm, and acquiring the fourth image through the image processor by controlling the digital imaging apparatus according to the second configuration setting.

The system of present invention comprises an image processor, a storage device and a processing unit. The image processor acquires a first image and a second image. The processing unit, coupling to the image processor and the storage device, acquires a first sub-image from the first image, acquires a second sub-image from the second image, determines whether the difference between the first sub-image and the second sub-image satisfies a predetermined condition, and, if so, acquires a third image via the image processor and stores the third image in the storage device.

The processing unit may convert RGB data of the first image into grayscale, halftone or luminance data thereof, and convert RGB data of the second image into grayscale, halftone or luminance data thereof before acquiring the first and second sub-images.

The processing unit may acquire a fourth image and a fifth image and determine analysis areas substantially with the same image formation from the fourth and the fifth image respectively. Pixel data between analysis areas of the fourth image and the fifth image may be substantially the same. The system may further comprise an autofocus motor driver, a shutter motor driver and a diaphragm motor driver. The processing unit may determine multiple first configuration settings of a first focal length and a first camera shutter under the maximum diaphragm. The image processor may acquire the fifth image after the processing unit controls the autofocus motor driver, the shutter motor driver and the diaphragm motor driver according to the first configuration settings. The processing unit may perform auto focus, automatic exposure determination and auto-white balance procedures to determine the first configuration settings of the first focal length and the first camera shutter under the maximum diaphragm. The processing unit may determine multiple second configuration settings of a second focal length, a first diaphragm and a second camera shutter. The image processor may acquire the fourth image after the processing unit controls the autofocus motor driver, the shutter motor driver and the diaphragm motor driver according to the second configuration settings. The processing unit may perform auto focus and automatic exposure determination procedures to determine the second configuration settings of the second focal length, the first diaphragm and the first camera shutter.

The image processor may acquire the first image, the second image and the third image after the processing unit controls the autofocus motor driver, the shutter motor driver and the diaphragm motor driver.

### BRIEF DESCRIPTION OF DRAWINGS

The invention will become more fully understood by referring to the following detailed description with reference to the accompanying drawings, wherein:

FIG. 1 is a diagram of a hardware environment applicable to an embodiment of a digital imaging apparatus;

FIG. 2 is a flowchart illustrating an embodiment of a method for automatic image acquisition;

FIGS. 3a and 3b are flowcharts illustrating an embodiment of a method for automatic image acquisition;

FIG. 4a is a bird's eye view diagram containing exemplary arrangements of a person, background and a tree to be shot;

FIG. 4b is a bird's eye view diagram containing exemplary arrangements of the person, background and tree;

FIG. 5a is an exemplary image corresponding to FIG. 4a;

FIG. 5b is an exemplary image corresponding to FIG. 4b;

FIG. 6 is a diagram of a storage medium storing a computer program for automatic image acquisition.

### DETAILED DESCRIPTION

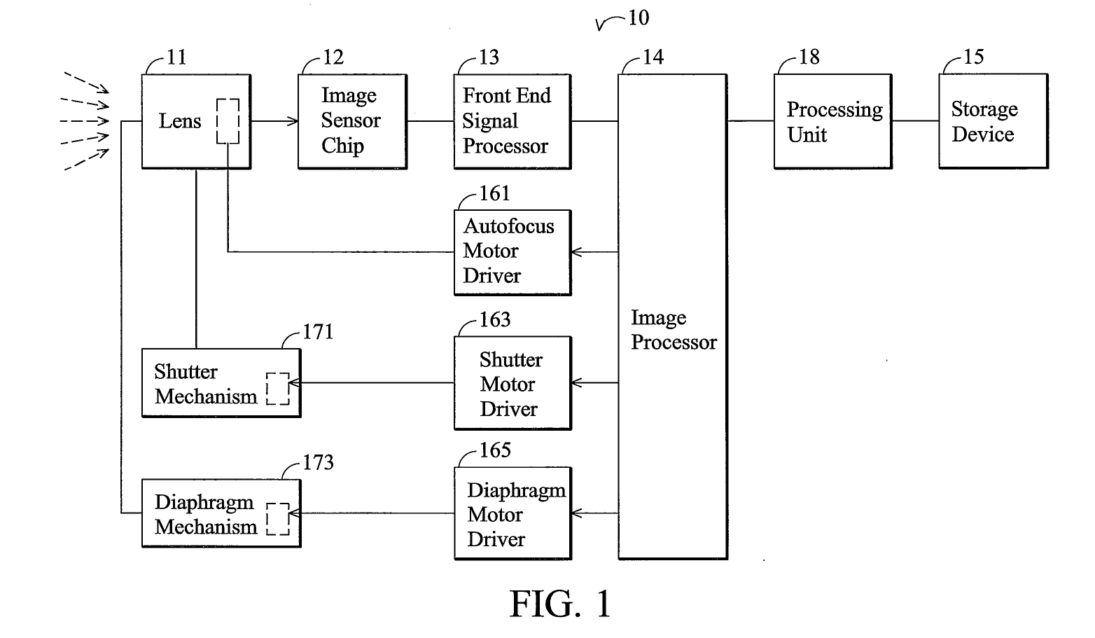

FIG. 1 is a diagram of a hardware environment applicable to an embodiment of a digital imaging apparatus 10 comprising lens 11, an image sensor chip 12, a front end signal processor 13, an image processor 14, a storage device 15, an autofocus motor driver 161, a shutter motor driver 163, a diaphragm motor driver 165, shutter mechanism 171, diaphragm mechanism 173 and a processing unit 18. Moreover, those skilled in the art will understand that some embodiments may be practiced with other portable electronic devices, including personal digital assistants (PDAs), mobile phones, portal programmable consumer electronics or similar. The digital imaging apparatus 10 records the intensity of light as variable charges in the image sensor chip 12 such as charge coupled device (CCD), complementary metal oxide semiconductor (CMOS) sensor chip or similar. The recorded charges being analog signals are transformed into digital signals by the front end signal processor 13, capable of storage in the storage device 15 such as a flash memory device, an optical disk drive, a hard disk drive or similar. The image processor 14 converts the sensed and transformed signals into image data in a particular format such as joint photographic experts group (JPEG), bitmap (BMP), graphics interchange format (GIF) or similar. The autofocus motor driver 161 couples to and controls a motor of autofocus lens 11 of the lens 11. The shutter motor driver 163 couples to and controls a motor of the shutter mechanism 171. The diaphragm motor driver 165 couples to and controls a motor of the diaphragm mechanism 173.

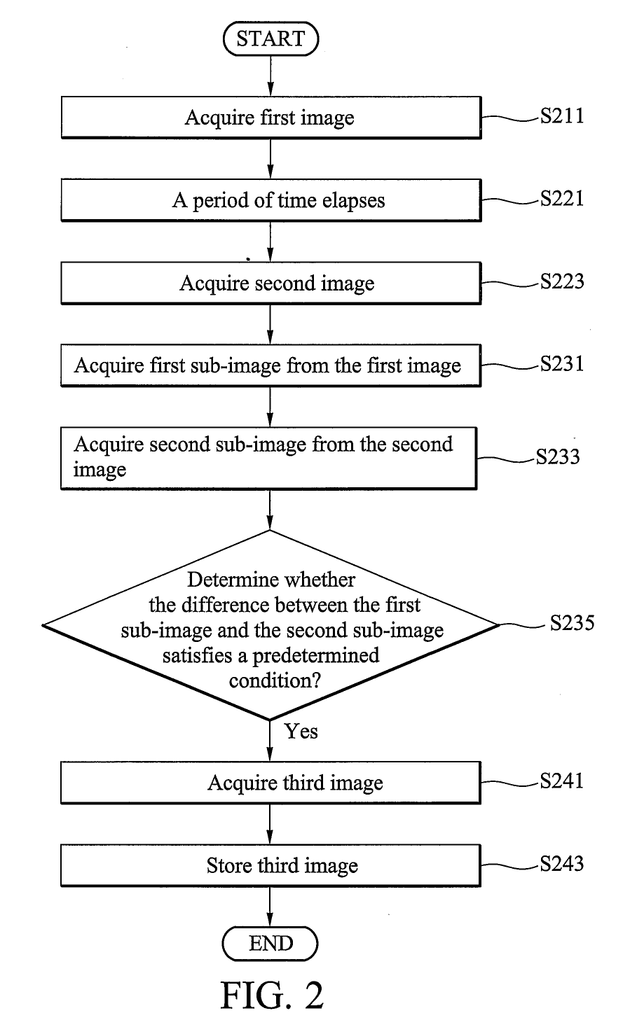

FIG. 2 is a flowchart illustrating an embodiment of a method for automatic image acquisition, performed by the processing unit 18 when loading and executing a computer program. In step S211, a first image is acquired. In step S221, the processing unit 18 is idle for a period of time. In step S223, a second image is acquired. In step S231, a first sub-image is acquired from the first image. In step S233, a second sub-image is acquired from the second image. In step S235, it is determined whether the difference between the first sub-image and the second sub-image satisfies a predetermined condition. If so, the process proceeds to step S241. The predetermined condition may indicate that the difference is higher or lower than a predetermined threshold. In step S241, a third image is acquired via the image processor 14. In step S243, the third image is stored in the storage device 15.

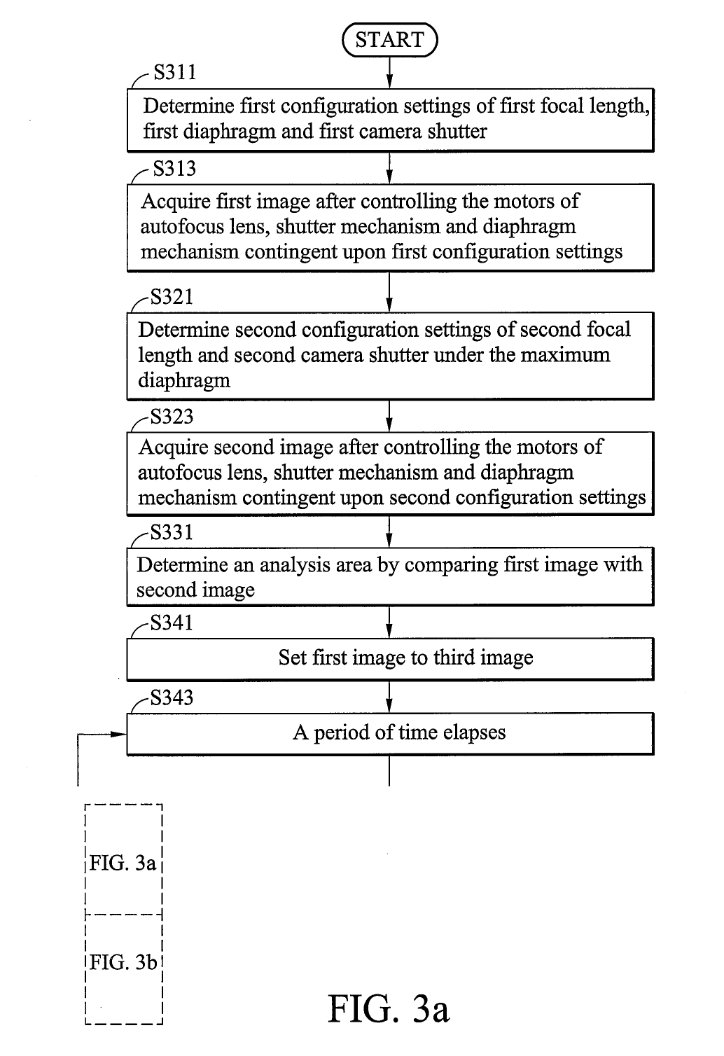

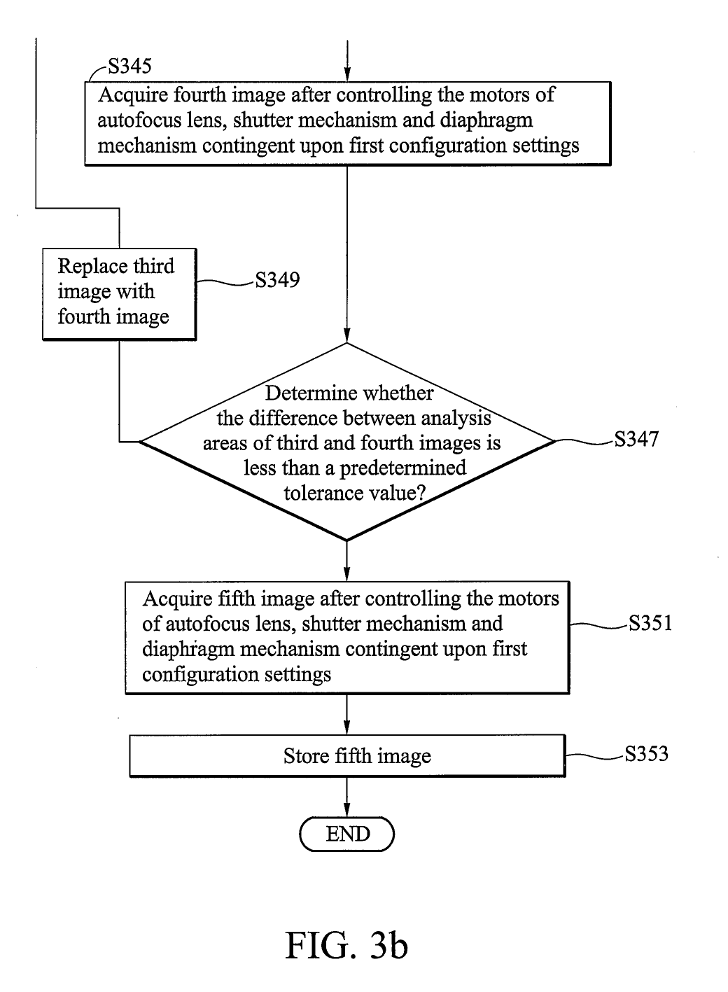

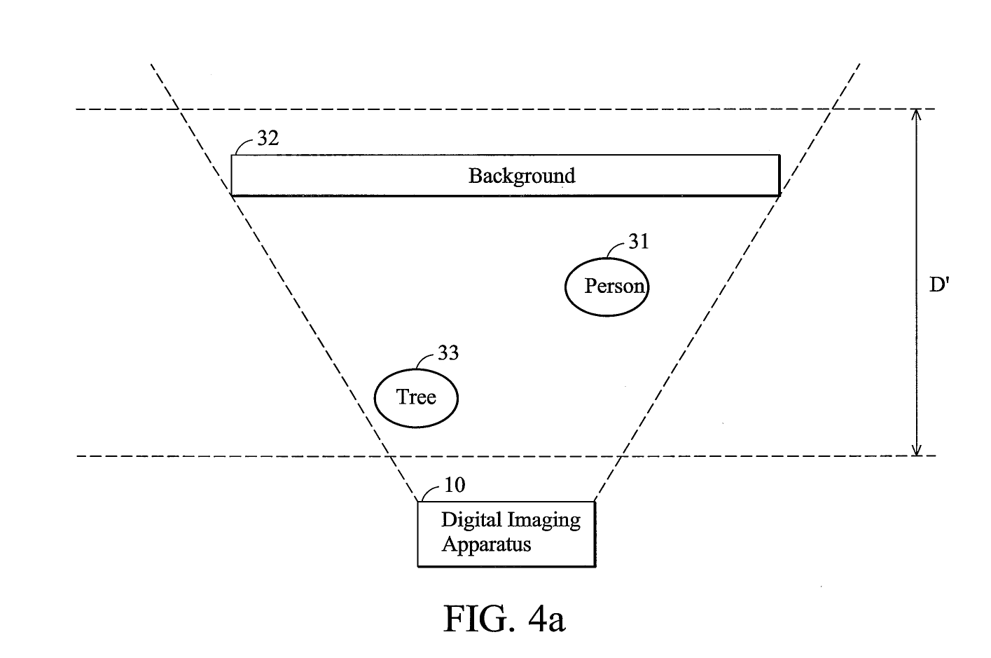

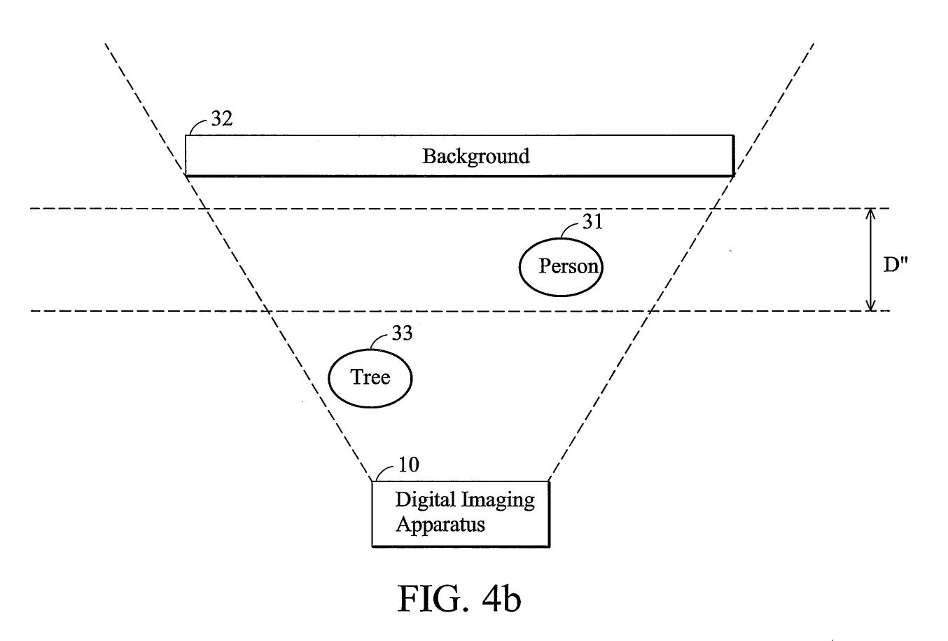

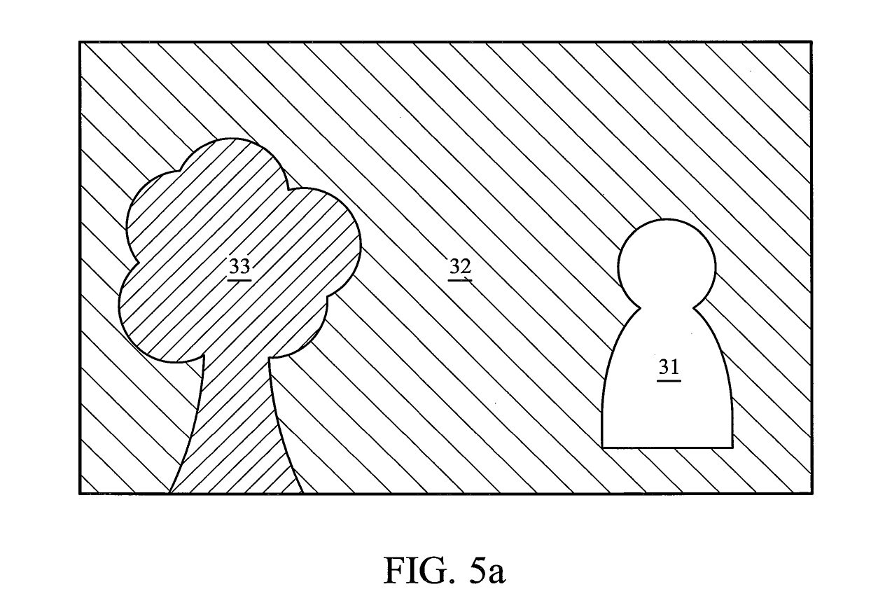

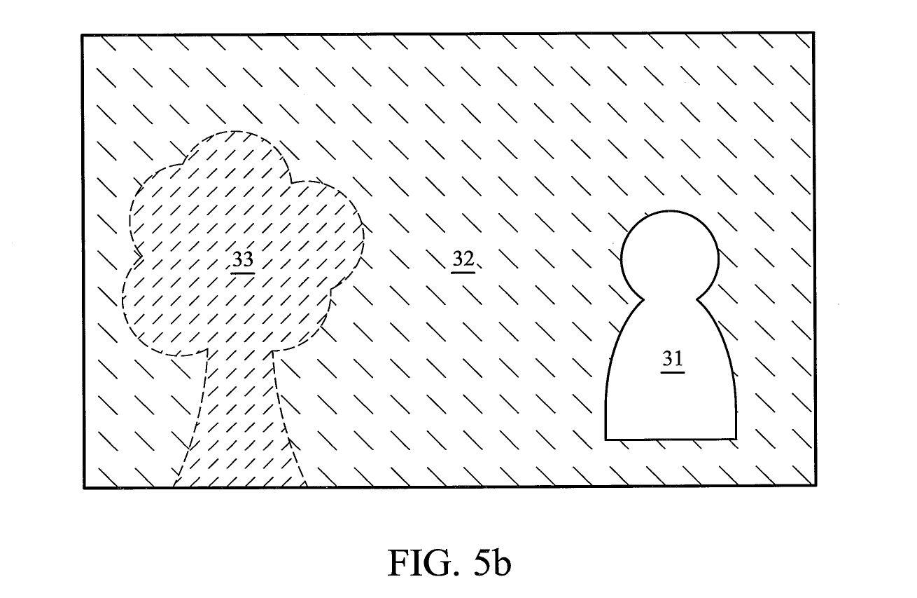

FIGS. 3a and 3b are flowcharts illustrating an embodiment of a method for automatic image acquisition, performed by the processing unit 18 when loading and executing a computer program. In step S311, first configuration settings of a first focal length, a first diaphragm and a first camera shutter are determined for a subject such as a person, a group of people, an animal or similar. Specifically, the first configuration settings are determined by focusing on the subject. Step S311 may determine the first configuration settings by auto focus (AF), automatic exposure (AE) determination and auto-white balance procedures. Those skilled in the art will realize that AF, AE determination and auto-white balance procedures are implemented by well-known algorithms briefly described herein. In step S313, a first image is acquired through the image sensor chip 12, front end signal processor 13 and image processor 14 after controlling the motors of the autofocus lens 11, the shutter mechanism 171 and the diaphragm mechanism 173 via the autofocus motor driver 161, shutter motor driver 163 and diaphragm motor driver 165 contingent upon the first configuration settings. In order to improve computing performance, RGB data of the first image may be converted into grayscale, halftone or luminance data, or similar data with reduced complexity. Those skilled in the art will realize that converting RGB data into grayscale, halftone or luminance data is implemented by well-known algorithms and briefly described herein. FIG. 4a is a bird's eye view diagram containing exemplary arrangements of a person 31, background 32 and a tree 33, to be shot and an exemplary depth of field D′ corresponding to the first configuration settings. FIG. 5a is an exemplary image corresponding to FIG. 4a, in which the person 31, background 32 and tree 33 have clear image formations because the person 31, background 32 and tree 33 fall within the depth of field D′.

In step S321, second configuration settings of a second focal length and a second camera shutter are determined under the maximum diaphragm for the same subject as that in step S311. Specifically, the second configuration settings are determined by focusing on the same subject. Step S321 may determine the second configuration settings by AF and AE determination procedures. In step S323, a second image is acquired through the image sensor chip 12, front end signal processor 13 and image processor 14 after controlling the motors of the autofocus lens 11, the shutter mechanism 171 and the diaphragm mechanism 173 via the autofocus motor driver 161, shutter motor driver 163 and diaphragm motor driver 165 contingent upon the second configuration settings. It is to be understood that RGB data of the second image should be correspondingly converted into grayscale, halftone or luminance data, or similar data with reduced complexity when RGB data of the first image has been converted into grayscale, halftone or luminance data, or similar data with reduced complexity. FIG. 4b is a bird's eye view diagram containing exemplary arrangements of the person 31, background 32 and tree 33 and an exemplary depth of field D″ corresponding to the second configuration settings. FIG. 5b is an exemplary image corresponding to FIG. 4b, in which only the person 31 has clear image formation because the person 31 falls within the depth of field D″.

In step S331, an analysis area is determined by comparing the first image with the second image. Step S331 detects that portions of pixel data (e.g. RGB, grayscale, halftone or luminance data) between the first and second images have the same or similar values therebetween by employing a well-known image difference detection algorithm, and thereafter determines an analysis area containing the detected portion. The difference of the detected portions of pixel data between the first and second images is less than a predetermined tolerance value. For example, the person 31 in both images, as shown in the FIGS. 5a and 5b, has clear formations, thus, the difference between the portions of images containing the person 31 is less than a predetermined tolerance value. Thereafter, the determined analysis area contains the person 31 of FIGS. 5a and 5b.

In step S341, the first image is set to a third image. A loop containing steps 343 and 349 is repeatedly performed until no subject movement is detected in the analysis area. In step S343, a period of time, such as 0.5 second, elapses. In step S345, a fourth image is acquired through the image sensor chip 12, front end signal processor 13 and image processor 14 after controlling the motors of the autofocus lens 11, the shutter mechanism 171 and the diaphragm mechanism 173 via the autofocus motor driver 161, shutter motor driver 163 and diaphragm motor driver 165 contingent upon the first configuration settings. It is to be understood that RGB data of the fourth image should be correspondingly converted into grayscale, halftone or luminance data, or similar data with reduced complexity when RGB data of the first image has been converted into grayscale, halftone or luminance data, or similar data with reduced complexity. In step S347, it is determined whether the difference between the analysis areas of the third and fourth images is less than a predetermined tolerance value. If so, the process proceeds to step S351, otherwise, to step S349. In step S349, the third image is replaced with the fourth image.

For example, when step S347 determines whether the difference between the analysis areas of the third and fourth images is less than a predetermined tolerance value, a loop containing steps S343 and S347 is repeatedly performed to compare an image with the subsequent image (i.e. compare the third image with the fourth image). No subject movement in the analysis area is detected when the difference between an image and the subsequent image is less than a predetermined tolerance value.

An embodiment of step S347 may determine whether the difference between the analysis areas of the third and fourth images is greater than a predetermined tolerance value. A loop containing steps S343 and S347 is repeatedly performed to compare an image with the subsequent image (i.e. compare the third image with the fourth image). Subject movement in the analysis area is detected when the difference between an image and the subsequent image is greater than a predetermined tolerance value.

In step S351, a fifth image is acquired through the image sensor chip 12, front end signal processor 13 and image processor 14 after controlling the motors of the autofocus lens 11, the shutter mechanism 171 and the diaphragm mechanism 173 via the autofocus motor driver 161, shutter motor driver 163 and diaphragm motor driver 165 contingent upon the first configuration settings. In step S353, the fifth image is stored in the storage device 15.

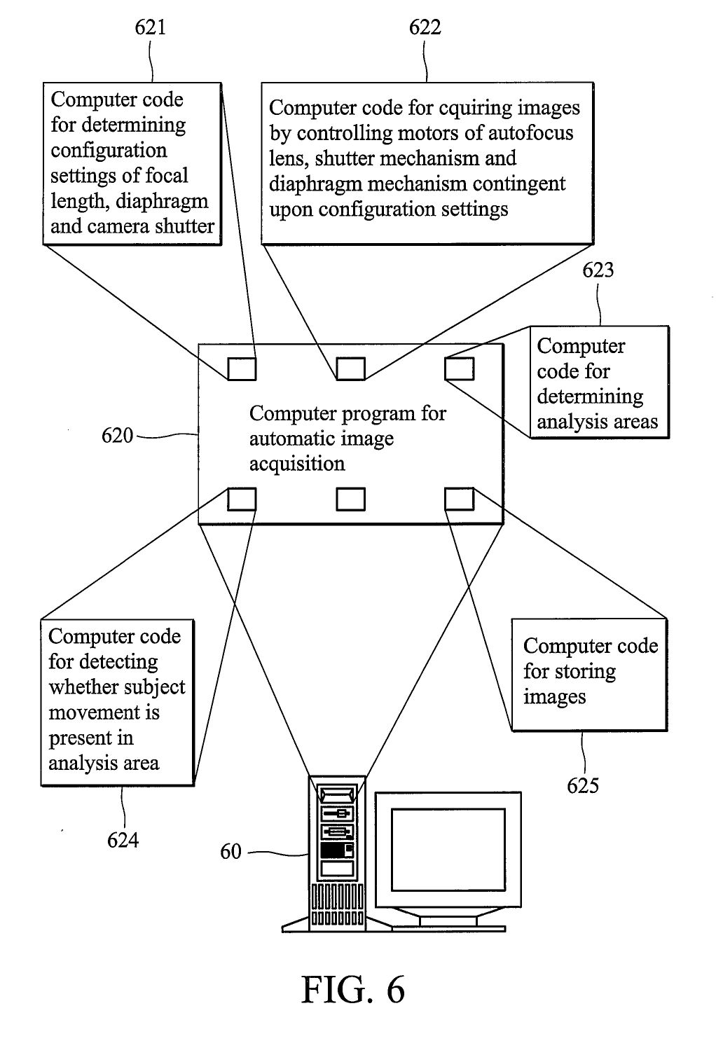

Also disclosed is a storage medium as shown in FIG. 6 storing a computer program 620 providing the disclosed methods for automatic image acquisition. The computer program includes a storage medium 60 having computer readable program code therein for use in a computer system. The computer readable program code comprises five logics 621 to 625. The computer logic 621 determines configuration settings of a focal length, a diaphragm and a camera shutter. The computer logic 622 acquires images by controlling the motors of autofocus lens, a shutter mechanism and a diaphragm mechanism contingent upon configuration settings. The computer logic 623 determines analysis areas. The computer logic 624 detects whether subject movement is present in analysis areas. The computer logic 625 stores images.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits. Systems and methods, or certain aspects or portions thereof, may take the form of electrical circuits embodied in digital imaging apparatuses.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for automatic image acquisition, applied in a digital imaging apparatus comprising an image processor and a storage device, comprising:
acquiring a first image;
acquiring a second image;
acquiring a first sub-image from the first image;
acquiring a second sub-image from the second image;
determining whether the difference between the first sub-image and the second sub-image satisfies a predetermined condition; and
acquiring a third image via the image processor and storing the third image in the storage device when the difference between the first sub-image and the second sub-image satisfies the predetermined condition.

2. The method as claimed in claim 1 further comprising converting RGB data of the first image into grayscale, halftone or luminance data thereof, and converting RGB data of the second image into grayscale, halftone or luminance data thereof before acquiring the first and second sub-images.

3. The method as claimed in claim 1, before acquiring the first and second images, further comprising:
acquiring a fourth image;
acquiring a fifth image; and
determining analysis areas substantially with the same image formation from the fourth image and the fifth image respectively.

4. The method as claimed in claim 3 wherein pixel data between analysis areas of the fourth image and the fifth image is substantially the same.

5. The method as claimed in claim 3 wherein the first sub-image is acquired from the analysis area of the first image, and the second sub-image is acquired from the analysis area of the second image.

6. The method as claimed in claim 3 wherein the step for acquiring the fifth image further comprises:
acquiring a first configuration setting by adjusting the digital imaging apparatus with the maximum diaphragm; and
acquiring the fifth image through the image processor by controlling the digital imaging apparatus according to the first configuration setting.

7. The method as claimed in claim 6 wherein the step for acquiring the fourth image further comprises:
determining a second configuration setting corresponding to a first diaphragm; and
acquiring the fourth image through the image processor by controlling the digital imaging apparatus according to the second configuration setting.

8. A system for automatic image acquisition comprising:
an image processor acquiring a first image and a second image;
a storage device; and
a processing unit coupling to the image processor and the storage device, acquiring a first sub-image from the first image, acquiring a second sub-image from the second image, determining whether the difference between the first sub-image and the second sub-image satisfies a predetermined condition, and, if so, acquiring a third image via the image processor and storing the third image in the storage device.

9. The system as claimed in claim 8 wherein the processing unit converts RGB data of the first image into grayscale, halftone or luminance data thereof, and converts RGB data of the second image into grayscale, halftone or luminance data thereof before acquiring the first and second sub-images.

10. The system as claimed in claim 8 wherein the processing unit is further for acquiring a fourth image and a fifth image and determining analysis areas substantially with the same image formation from the fourth image and the fifth image respectively.

11. The system as claimed in claim 10 wherein pixel data between analysis areas of the fourth image and the fifth image is substantially the same.

12. The system as claimed in claim 10 further comprising an autofocus motor driver, a shutter motor driver and a diaphragm motor driver.

13. The system as claimed in claim 12 wherein the processing unit determines a plurality of first configuration settings of a first focal length and a first camera shutter under the maximum diaphragm, and the image processor acquires the fifth image after the processing unit controls the autofocus motor driver, the shutter motor driver and the diaphragm motor driver according to the first configuration settings.

14. The system as claimed in claim 13 wherein the processing unit performs auto focus, automatic exposure determination and auto-white balance procedures to determine the first configuration settings of the first focal length and the first camera shutter under the maximum diaphragm.

15. The system as claimed in claim 14 wherein the processing unit determines a plurality of second configuration settings of a second focal length, a first diaphragm and a second camera shutter, and the image processor acquires the fourth image after the processing unit controls the autofocus motor driver, the shutter motor driver and the diaphragm motor driver according to the second configuration settings.

16. The system as claimed in claim 15 wherein the processing unit performs auto focus and automatic exposure determination procedures to determine the second configuration settings of the second focal length, the first diaphragm and the first camera shutter.

17. The system as claimed in claim 8 further comprising an autofocus motor driver, a shutter motor driver and a diaphragm motor driver, wherein the image processor acquires the first image, the second image and the third image after the processing unit controls the autofocus motor driver, the shutter motor driver and the diaphragm motor driver.
